(19) United States
(12) Patent Application Publication
(10) Pub. No.: US 2025/0157449 A1
(43) Pub. Date: May 15, 2025

(54) SOUND DAMPING PANEL ASSEMBLY AND METHOD THEREOF

(71) Applicant: Daniel Martinson, Fridley, MN (US)

(72) Inventor: Daniel Martinson, Fridley, MN (US)

(21) Appl. No.: 18/948,448

(22) Filed: Nov. 14, 2024

Related U.S. Application Data
(60) Provisional application No. 63/548,391, filed on Nov. 14, 2023.

(51) Int. Cl. G10K 11/172

(52) U.S. Cl. CPC G10K 11/172

(57) ABSTRACT

A panel assembly having a core portion positioned or formed in between a first panel portion and a second panel portion. One or more chambers can be formed between the first panel portion and the second panel portion by one or more sidewalls of the core portion. One or both panel portions can include one or more apertures that can correspond to a respective interior chamber formed between the first panel portion and the second panel portion. The core portion, first panel portion, and second panel portion can be comprised of the same material. The core portion can take any suitable configuration, including but not limited to a hexagonal honeycomb configuration.

### CROSS-REFERENCE

This Patent application claims priority to U.S. Provisional Application 63/548,391 filed Nov. 14, 2023, the disclosure of which is considered part of the disclosure of this application and is hereby incorporated by reference in its entirety.

### FIELD OF THE INVENTION

This invention relates generally to building panels, preferably but not limited to sound damping panels. Additionally, the disclosure relates to thermoplastic material and resins for manufacturing panel boards that can have sound damping properties as well as printable surfaces.

### BACKGROUND

In the building and material production industry, it is known various types of panels have been developed for various types of applications with specific features to suit environmental needs. In some environments including racquet sports and fenced in surrounding areas it is desirous to have walls or fencing that can blend into the environment. Additionally, it would be advantageous for the material to absorb sounds to limit noises in residential and/or park areas. Currently most fenced in courts utilize chain linked fencing which does not absorb any sound and similarly require banners that can be easily dislodged or blown off the fencing to provide an advertising surface. Additionally, current non-chain linked fences such as mass loaded vinyl are unable to adequately absorb sound and block noise. Furthermore, open cell foam panels often times absorb moisture and are unable to be recycled.

There exists a need for building panels that can absorb sound while additionally being able to be graphic printed to blend into surroundings or alternatively be used as market or branding opportunities depending on a user's needs.

### BRIEF SUMMARY OF THE INVENTION

In one aspect, this disclosure is related to a panel assembly having a core positioned or formed in between a first sheet and a second sheet. The core, first sheet, and second sheet can be comprised of the same material. The core can take any suitable configuration, including but not limited to a hexagonal honeycomb configuration.

In yet another aspect, the present disclosure is related to a method of manufacturing a panel assembly of the present disclosure by sandwiching and thermowelding a core portion between a first sheet and a second sheet to form a thermoplastic panel board.

In yet another aspect, the present disclosure is related to a panel assembly including a core portion having a first edge and a second edge. The height of the core portion can be defined by the length of a sidewall between the first edge and second edge of the core portion. A first panel portion can be coupled to the first edge of the core portion and a second panel portion can be coupled to the second edge of the core portion. Each of the first panel portion and second panel portions can have an exterior surface and an interior surface. The core portion, first panel portion, and second panel portion can be comprised of the same material. One or more interior chambers can be formed between the first panel portion and second panel portion by the core portion. The one or more interior chambers can take any suitable configuration. The first panel portion can include at least one aperture configured to allow a sound waves from an exterior environment to into the one or more interior chambers through the one or more apertures of the panel assembly to dissipate the sound waves. The one or more interior chambers can be hexagonal in shape. In some exemplary embodiments, the core portion can be a hexagonal honeycomb configuration. A printable polypropylene film can be applied to the exterior surface of one or both of the first or second panel portions. The film can be corona treated and allow for a graphic to be applied or printed to the film.

In yet another aspect, the present disclosure relates to a method of reducing sound waves and reverberation around an enclosed environment utilizing one or more of the panel assemblies of the present disclosure. One or more pane uni-directional or bi-directional sound damping panels can be positioned to interface with sound waves and configured to penetrate the panel assembly through the apertures and into the chambers.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective cutaway view of an exemplary embodiment of a panel assembly of the present disclosure.

FIG. 2A is a front side view of an exemplary embodiment of a panel assembly of the present disclosure.

FIG. 2B is a back side view of an exemplary embodiment of a panel assembly of the present disclosure.

FIG. 2C is a side view of an exemplary embodiment of a panel assembly of the present disclosure.

FIG. 2D is an interior cross-sectional view of the second side an exemplary embodiment of a panel assembly of the present disclosure along axis B-B of FIG. 2C.

FIG. 2E is an interior cross-sectional view of the first side an exemplary embodiment of a panel assembly of the present disclosure with perforations.

FIG. 3A is a first side view of an exemplary embodiment of a panel assembly of the present disclosure.

FIG. 3B is an interior cross-sectional view of the first side an exemplary embodiment of a panel assembly of the present disclosure with perforations.

FIG. 3C is a second side view of an exemplary embodiment of a panel assembly of the present disclosure.

FIG. 3D is an interior cross-sectional view of the second side an exemplary embodiment of a panel assembly of the present disclosure.

FIG. 4 is a graphic illustration of sound damping performance based on panel thickness.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS., with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

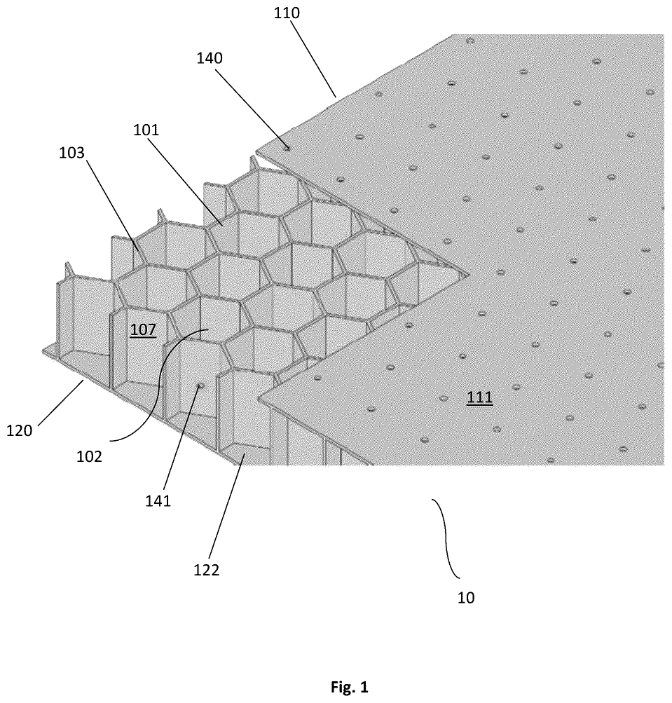

As shown in FIGS. 1-3, some exemplary embodiments of a panel assembly 10 of the present disclosure can include a core portion 101, a first panel or skin 110, and a second panel or skin 105. Each panel/skin 110, 120 can have respective first surface 111,121 and a second surface 112,122. In some exemplary embodiments, the panel portions 110,120 can have perforations 140 or apertures. Alternatively, the one or more of the panels 110,120 can be solid in construction without any perforation 140. The panel assembly 10 can be comprised of any suitable material. In some exemplary embodiments a core portion 101 can utilize a thermoplastic material for the construction of one or more of the panel portions 110,120. The panels 110,120 can have any suitable thickness between about 0.1 mm to about 10 mm. The thickness of the panel apparatus 10 can be any desired thickness by increasing or decreasing the thickness of the panel skin portion(s) 110,120 and/or the height of the core portion 101.

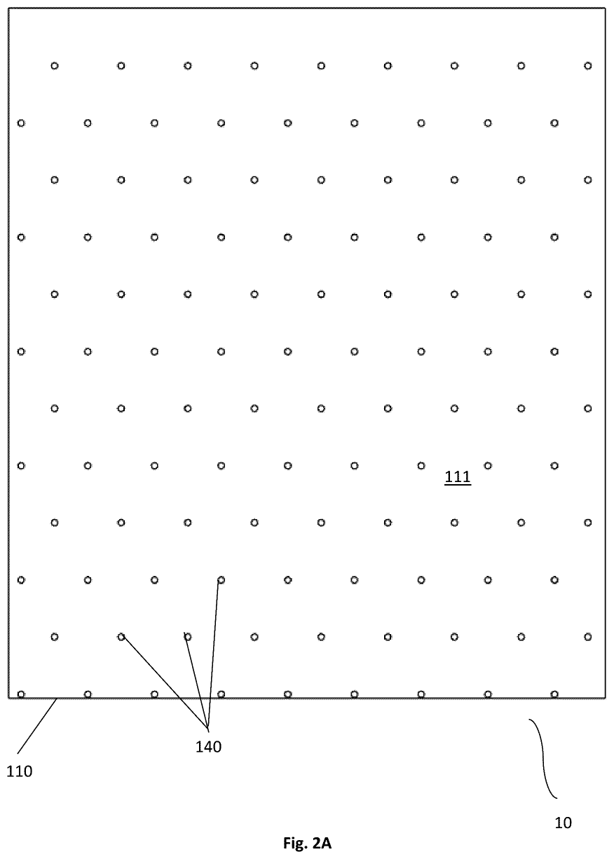

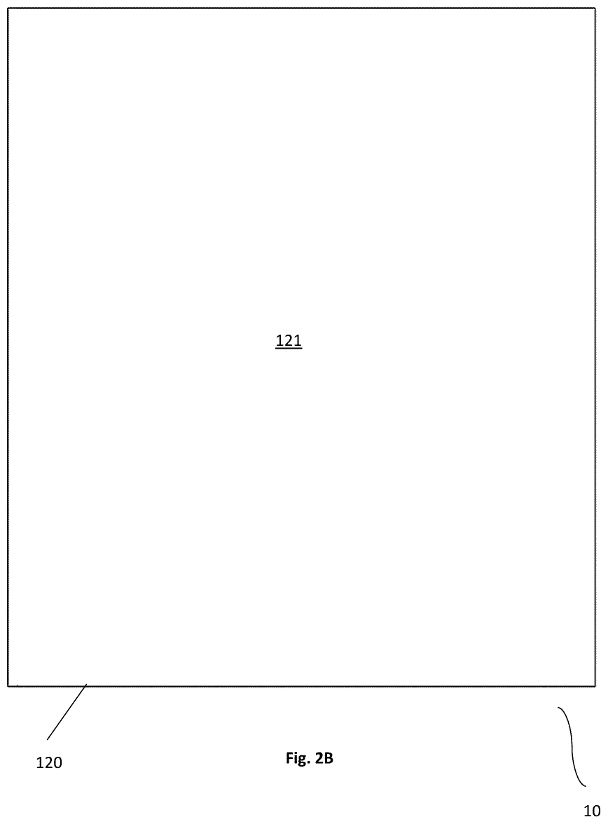

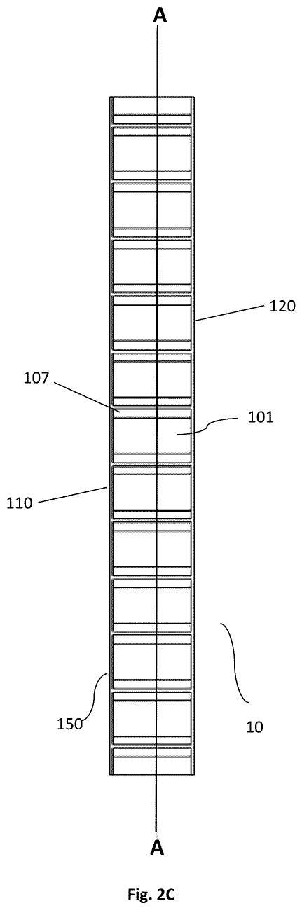

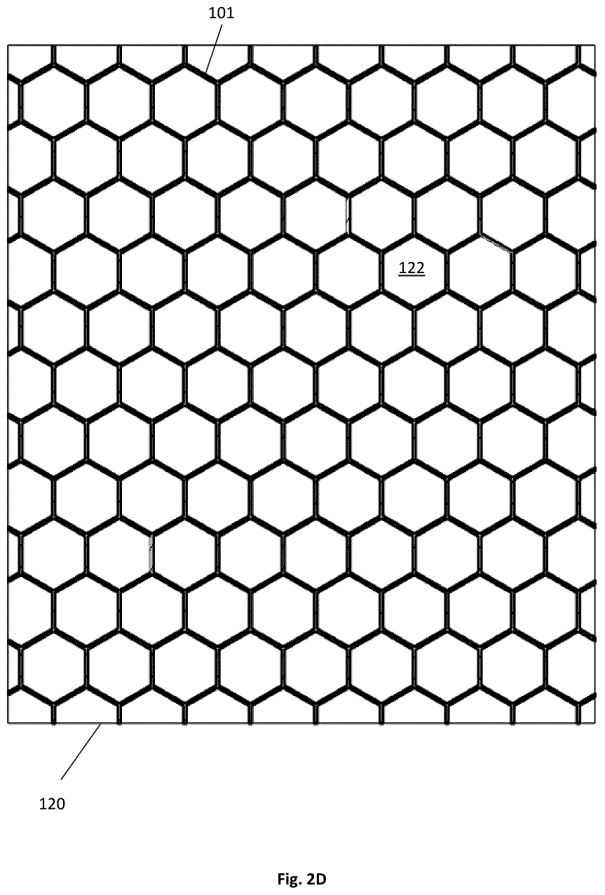

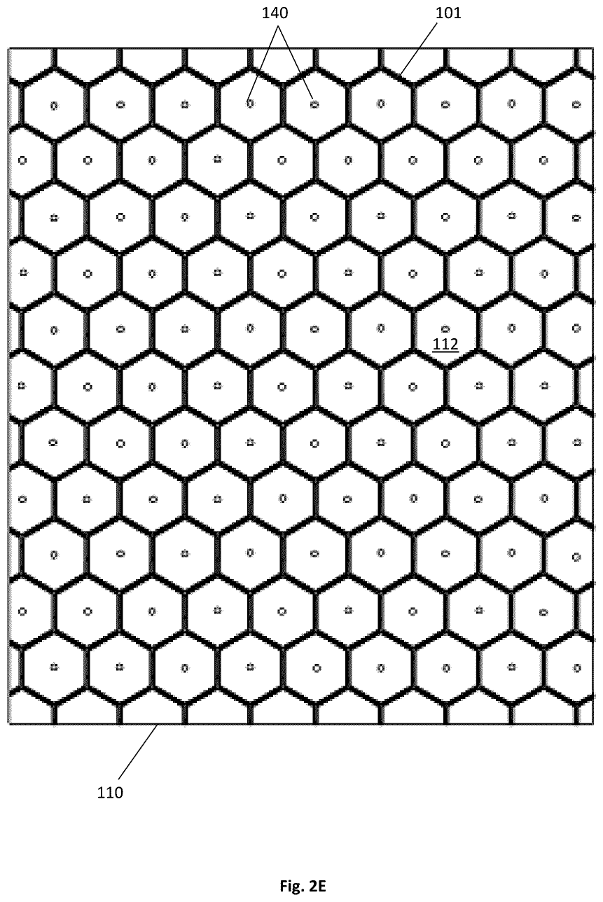

In one exemplary embodiment, one of the panels can have perforations while the other panel may be a solid panel as shown in FIGS. 2A-E. At least one panel portion 111 can have a perforation 140 that corresponds to each chamber 102 formed between the first panel portion 110 and second panel portion 120 as shown in FIG. 2A. The other panel portion 120 can similarly have perforation or alternatively be solid without any perforations as shown in FIG. 2B. The core portion 101 can take any suitable configuration and structure as desired. As shown in FIG. 1, the core portion 101 can be configured to include a plurality of chambers 102. In some exemplary embodiments, the chambers 102 can be a hexagonal honeycomb configuration to provide greater stability as well as limit the weight of the panel apparatus 10.

The interior surface 112 of the first panel 110 can be coupled to the first side or edge 103 of the core portion 101. Similarly, the interior surface 122 of the second panel portion 120 be coupled to the second side or edge 105 of the core portion 101. The panels 110,120 can be coupled to the core portion 101 utilizing any suitable method. In some exemplary the core portion 101 can be comprised of the same material as the one or more of the panel portions 110,120. The core portion 101 can be comprised of any suitable material including but not limited to a thermoplastic. This can allow the two panel portions 110,120 to be thermocoupled/welded to the core portion 101 to form an exemplary embodiments of rigid panel assembly 10 of the present disclosure.

The panel portions 11,120 can include one or more apertures/perforations 140 through the panel that can pass between the first side 111,121 and the second side 112,122 of the panel. In some exemplary embodiments, the apertures 140 can be positioned about center to the center of one or more of the chambers 102 of the core portion 101. The apertures 140 can be any suitable size including between about 0.1-3 mm or about 1 mm. Each panel portion 110,120 can have apertures 140 on each side of the panel assembly 10 of the present disclosure. The apertures 140 can allow for some air and/or sound waves to enter chamber(s) of the panel and can aid in acoustic performance and insulation characteristics. In some exemplary embodiments, only one panel portion 110,120 can have perforations 140 and the other skin/panel can have no perforations. The panel portions 110,120 can have any suitable thickness and can have an interior core portion 101 as well in some exemplary embodiments. The perforations 140 can take any suitable configuration. In some exemplary embodiments, the perforations 140 can be formed for every chamber 102 or alternative only a few of the chambers.

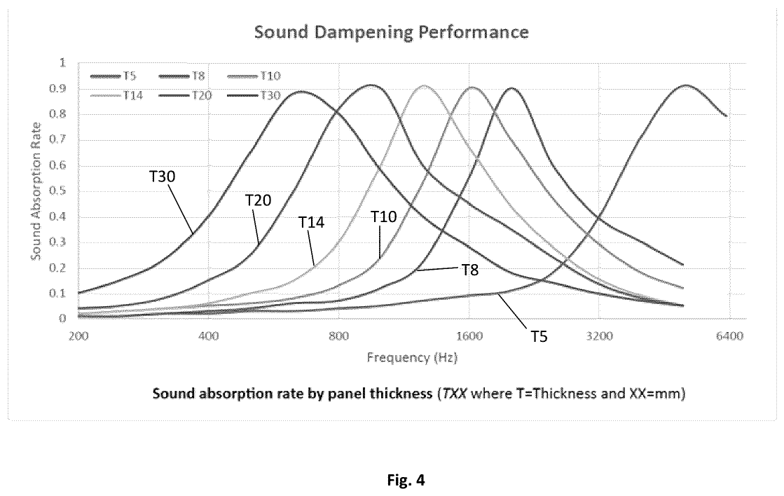

The core portion 101 can be comprised of a plurality of chambers 102. In some exemplary embodiments, the interior chambers can be formed into a hexagonal honeycomb configuration with various sidewalls 107 that can have a first sidewall height. The sidewall height can be any described length depending upon the nature and desired use of the panel. The height of the sidewall can be determined by the distance between the first and second panels. The sidewall height can determine a thickness of the rigid panel. In some exemplary embodiments, the sidewalls 107 of the core portion can have one or more perforations between the chambers. In some exemplary embodiments, the sidewalls 107 within the core portion can additionally include apertures 141 or perforations that can interconnect the various chambers 102 of the core portion. The sidewall perforations 141 can potentially further dissipate or dampen sound waves. Similarly, the sidewall apertures 141 can aid in draining any moisture captured in the chambers 102. Various different sized cores can affect the sound damping performance and insulative performance of the panels as shown in FIG. 4.

Exemplary embodiments of the panel assembly 10 of the present disclosure can provide sound energy absorption. Sound waves can enter the panel core chambers 102, and the honeycomb members and/or sidewalls 107 can act as a sound energy absorption membrane. Thick panels can absorb approximately 90% of lower frequency sound while thinner panels absorb approximately 90% high frequency sounds. The frequency with which peak 90% sound absorption is observed can increase exponentially as core thickness is reduced. The panel assembly 10 can have a thickness between about 1 to about 100 mm or between about 3 mm to about 90 mm or between about 5 and 30 mm. The sidewalls 107 of the core portion 101 can be used to form chambers 102 within the panel assembly once the panel portions are coupled to the core portion 102.

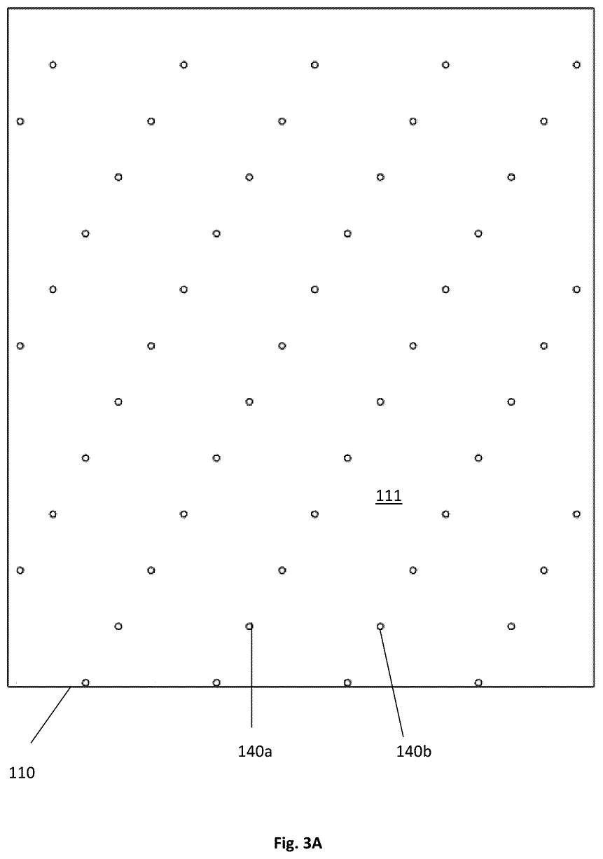

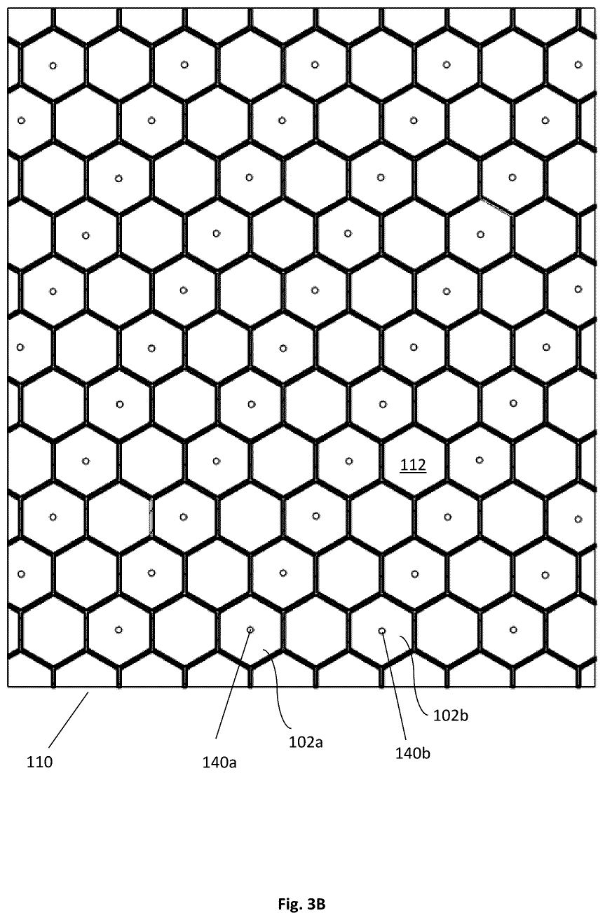

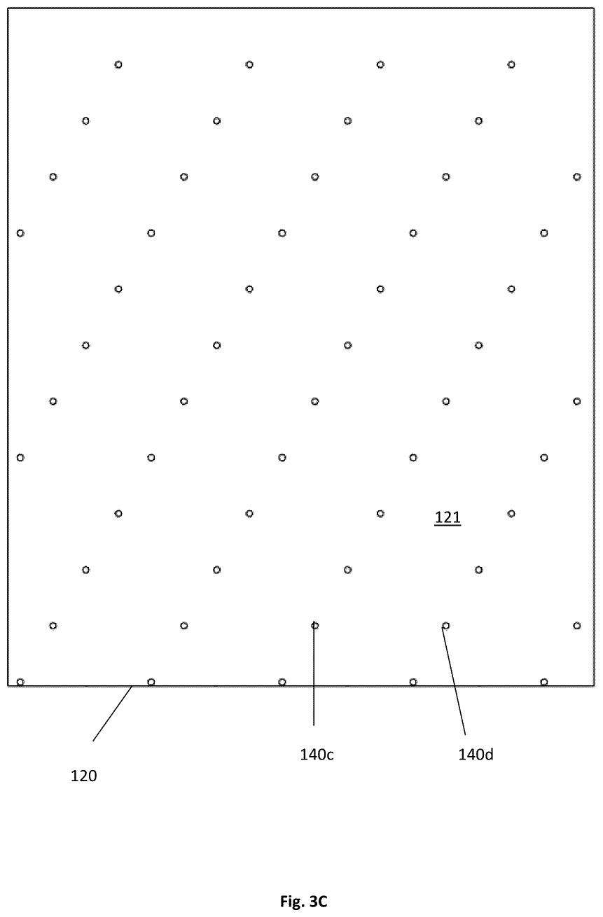

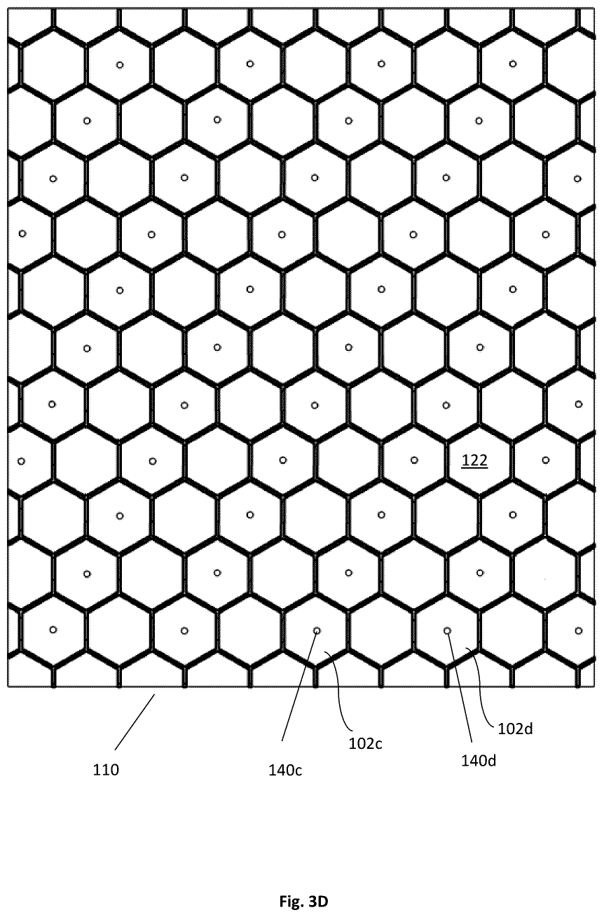

As shown in FIG. 3A-D, cross sectional views of an exemplary embodiments can have perforations 140 that can be formed on a first panel 110 and prescribed to a first set of one or chambers 102 and a second panel 120 can have a second set of perforations 140 prescribed to a second set of chambers 102. FIGS. 3A-B provide an illustration of a first panel 110 having one or more perforations 140a,b that correspond to a specific chambers 102a, 102b. FIG. 3A provides a top surface 111 of a first panel portion 10, whereas FIG. 3B provides the underside surface 112 of the first panel portion 110 with the corresponding perforations 140a,b for the prescribed chambers 102a, 102b. FIG. 3C provides an illustration of a second panel portion 120 having a top surface 121 with a plurality of perforations 140c,d that can correspond to one or more chambers 102c,d of the core portion 102. FIG. 3D provides an illustration of the interior surface 122 of the second panel portion 120 and the corresponding perforations 140c,d and chambers 102c,d. The first set and second set of chambers can be different with little or no overlap. In some embodiments both the first panel and second panel can include perforations or alternatively only one panel can have perforations. As shown in FIGS. 3A-E one side of the panel apparatus 10 can have perforations 140a,b that correspond to a first set of chambers 102a,b and the second panel portion 120 can have perforations 140c,d that correspond to a second set of chambers 102c,d. The first set of chambers 102a,b can be different from the second set of chambers 102c,d. Alternatively, both panel portions 110, 120 can have perforations that correspond to all chambers 102. It should be understood that any desired perforation pattern or amount can be provided depending upon the desired application.

In some exemplary embodiments, the exterior surface 111,121 of one or more panel portions 110,120 of the panel assembly 10 can further include printable film layer 150 than can then allow for graphics to be printed on one or more of the exterior surfaces of the panel assembly. The film layer 150 can be of any suitable material, including but not limited to polypropylene that can be corona treated to allow for the film layer 150 to be printed on and provide various ability for a user to add graphics. This can allow users to custom print the panels 110,120 to add sponsorship graphics, event information, or printed to blend into the surrounds of the desired environment.

The configurations of the perforations 140 can provide for either a uni-directional or bi-directional sound damping. In some exemplary embodiments, a panel assembly 10 can be adapted to be a uni-directional sound damping panel by having perforation on only a first side panel portion 110. This can aid in absorbing sound from the direction that the perforations are facing. In other embodiments, a multi-directional sound damping panel assembly can be configured to have perforations on both panel sides 110,120. Depending upon the layout of application of the desired area for sound damping, one or more different types of panel assemblies can be utilized. In some exemplary embodiments, where multiple courts or defined areas are configured to be side by side each other a bi-directional sound panel may be utilized while on the exterior borders of the courts or defined area a uni-directional panel assembly 10 could be utilized. The bi-directional panels can take multiple configurations as previously illustrated with perforations on each side of every chamber or for designated chambers for each side. In one exemplary method a court can provide one or more sound damping panels to a preexisting fence, wherein the panel assemblies 10 include one or more perforations 140 configured to aid in sound damping by absorbing sound waves into chambers 102 through the perforations. The sounds waves can enter the chambers 140 and bounce within the interior chambers 102 thereby cancelling out the sound waves and damping the sound of the outside environment. Alternatively, the panel assemblies 10 themselves can be used for barrier construction as a standalone fence.

In various embodiments wherein all of the components are constructed out of any suitable thermoplastic material, including but not limited to polypropylene, the panels can be recycled and reused to construct new panels as the old panel assembly where over time. This reduces waste and allows for sustainable use of the panels for future events. The panel assemblies 10 can also be configured to easily replace existing chain link fences by removing the chain link portion and replacing them with the panel assemblies. The panel assemblies 10 can absorb noise in addition to blocking noise from entering exterior environments. The panels also result in less of an echo effect in an enclosed space. The panels 10 can also be formed into any desired configuration to replace other types of fences include wooden slate, vinyl, or picket fences.

Dependent upon the thickness of the panels, sidewalls of the core portion, the thickness of the core portion, and the density can reflect and reduce the amount of frequency waves that make it through the panel. FIG. 4 provides a graphical illustration of sound damping characteristics of some exemplary embodiments based upon the thickness of the panel assemblies 10. The panels can be used for other suitable purposes including enclosures, walls, and other uses to help damp and or absorb sound waves. The panel composition can additionally provide UV stability and allow for exterior uses without degradation. Similarly, the construction of the panels allows for on-site construction and fabrication with common equipment. Unlike other fencing products, the panels do not result in damage to the panels that can lead to corrosion that would happen to metal components fabricated on a job site.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A panel assembly comprising:
a core portion positioned and coupled to a first panel portion having an exterior surface and an interior surface and a second panel portion having an exterior surface and an interior surface, wherein the core portion, first panel portion, and second panel portion can be comprised of the same material,
wherein the core portion includes one or more interior chambers between the interior surface of the first panel and the interior surface of the second panel,
wherein the first panel portion includes at least one aperture configured to allow a sound waves to into the one or more interior chambers of the panel assembly to dissipate the sound waves.

2. The panel assembly of claim 1, wherein the interior chambers are in a hexagonal shape.

3. The panel assembly of claim 1, wherein the exterior surface of at least one of the first panel portion or second panel portions can further include a polypropylene film applied that is corona treated to the exterior surface.

4. The panel assembly of claim 3, wherein the polypropylene film is configured to accept graphical printing.

5. The panel assembly of claim 1, wherein the second panel portion includes at least one aperture configured to allow a sound waves to into the one or more interior chambers of the panel assembly to dissipate the sound waves.

6. The panel assembly of claim 1, wherein a plurality of chambers is formed between the first panel portion and the second panel portion, wherein each aperture of a plurality of apertures corresponds to a specific chamber of the plurality of chambers.

7. The panel assembly of claim 1, wherein the first panel portion includes a first set of apertures that corresponds to a respective first set of interior chambers.

8. The panel assembly of claim 7, wherein the second panel portion includes a second set of apertures that correspond to a respective second set of interior chambers.

9. The panel assembly of claim 8, wherein the first set of interior chambers is the same as the second set of interior chambers.

10. The panel assembly of claim 8, wherein the first set of interior chambers is different from the second set of interior chambers.

11. The panel assembly of claim 7, wherein the second panel portion is sold with no apertures.

12. The panel assembly of claim 11, wherein the core portion, first panel portion, and second panel portion are comprised of a thermoplastic material, wherein the core portion is thermowelded to the interior surface of the first panel portion on a first side of the core portion and thermowelded to the interior portion of the second panel portion on the second side of the core portion.

13. The panel assembly of claim 12, wherein the interior chambers are in a hexagonal configuration.

14. The panel assembly of claim 13, wherein the exterior surface of at least one of the first panel portion or second panel portions can further include a polypropylene film applied that is corona treated to the exterior surface.

15. The panel assembly of claim 14, wherein the polypropylene film includes a graphic.

16. The panel assembly of claim 15, wherein the hexagonal chamber is configured to deflect sound waves within the interior chambers to further dissipate the sound level from an external environment.
